(19) United States
(12) Patent Application Publication
(10) Pub. No.: US 2012/0212589 A1
(43) Pub. Date: Aug. 23, 2012

(54) PLAYBACK METHODS AND PLAYBACK APPARATUSES FOR PROCESSING MULTI-VIEW CONTENT

(76) Inventor: Min-Hung Chien, Taichung City (TW)

(21) Appl. No.: 13/031,242

(22) Filed: Feb. 20, 2011

(51) Int. Cl. H04N 13/04

(52) U.S. Cl. 348/51; 348/E13.001

(57) ABSTRACT

A playback method for processing a multi-view content includes: detecting a location of each viewer and accordingly generating a detecting result; and driving a display device according to the multi-view content and the detecting result. A playback apparatus for processing a multi-view content includes a detecting circuit and a driving circuit. The detecting circuit is arranged to detect a location of each viewer and accordingly generate a detecting result. The driving circuit is coupled to the detecting circuit, and implemented for driving a display device according to the multi-view content and the detecting result.

### BACKGROUND

The disclosed embodiments of the present invention relate to video processing, and more particularly, to playback methods and playback apparatuses for processing a multi-view content.

With the development of the science and technology, users are pursuing three-dimensional (3D) and more real video outputs rather than high quality video outputs. There are two techniques of present 3D video display. One is to use a video display apparatus which collaborates with 3D glasses (e.g., anaglyph glasses, polarization glasses or shutter glasses), while the other is to directly use a video display apparatus without any accompanying 3D glasses. No matter which technique is utilized, the main principle of the 3D video display is to make the left eye and right eye see different images, thus the brain will regard the different images seen from two eyes as 3D video images.

For shutter glasses, they are widely used for a user to watch the 3D video content presented on the video display apparatus. The shutter glasses include two shutter lenses, and allow user's left eye to see left-eye images and user's right eye to see right-eye images via properly switching the shutter lens between an open state and a close state. However, when more than one user is watching the 3D video content displayed via the same video display apparatus, the 3D viewing experience may be different if the users have different viewing angles with respect to the video display apparatus. For example, a first user sitting directly in front of the video display apparatus may have the best 3D viewing experience, whereas a second user sitting next to the first user may have degraded 3D viewing experience.

Thus, there is a need for an innovative playback design of the video content for allowing different users to have better 3D viewing experience.

### SUMMARY

In accordance with exemplary embodiments of the present invention, playback methods and playback apparatuses for processing a multi-view content are proposed to solve the above-mentioned problem.

According to a first aspect of the present invention, an exemplary playback method for processing a multi-view content is disclosed. The exemplary playback method includes: detecting a location of each viewer and accordingly generating a detecting result; and driving a display device according to the multi-view content and the detecting result.

According to a second aspect of the present invention, an exemplary playback apparatus for processing a multi-view content is disclosed. The exemplary playback apparatus includes a detecting circuit and a driving circuit. The detecting circuit is arranged to detect a location of each viewer and accordingly generate a detecting result. The driving circuit is coupled to the detecting circuit, and implemented for driving a display device according to the multi-view content and the detecting result.

According to a third aspect of the present invention, an exemplary playback method for processing a multi-view content is disclosed. The exemplary playback method includes: receiving the multi-view content including at least a first display data and a second display data respectively corresponding to different predetermined viewing angles; and driving a display device to display part of the first display data and part of the second display data in a time division manner.

According to a fourth aspect of the present invention, an exemplary playback apparatus for processing a multi-view content is disclosed. The exemplary playback apparatus includes: a receiving circuit and a driving circuit. The receiving circuit is arranged to receive the multi-view content including at least a first display data and a second display data respectively corresponding to different predetermined viewing angles. The driving circuit is coupled to the receiving circuit, and implemented for driving a display device to display part of the first display data and part of the second display data in a time division manner.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a playback apparatus according an exemplary embodiment of the present invention.

FIG. 2 is a diagram illustrating a first operational scenario where a single viewer is watching the display device.

FIG. 3 is a diagram illustrating the operation of presenting the 3D video content to the viewer according to the first operational scenario.

FIG. 4 is a diagram illustrating a second operational scenario where multiple viewers are watching the same display device.

FIG. 5 is a diagram illustrating the operation of presenting the 3D video content to the viewers according to the second operational scenario.

FIG. 6 is a diagram illustrating an exemplary implementation of the selection module shown in FIG. 1.

FIG. 7 is a diagram illustrating a third operational scenario where multiple viewers are watching the same display device.

FIG. 8 is a diagram illustrating the operation of presenting the 3D video content to the viewers according to the third operational scenario.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is electrically connected to another device, that connection may be through a direct electrical connection, or through an indirect electrical connection via other devices and connections.

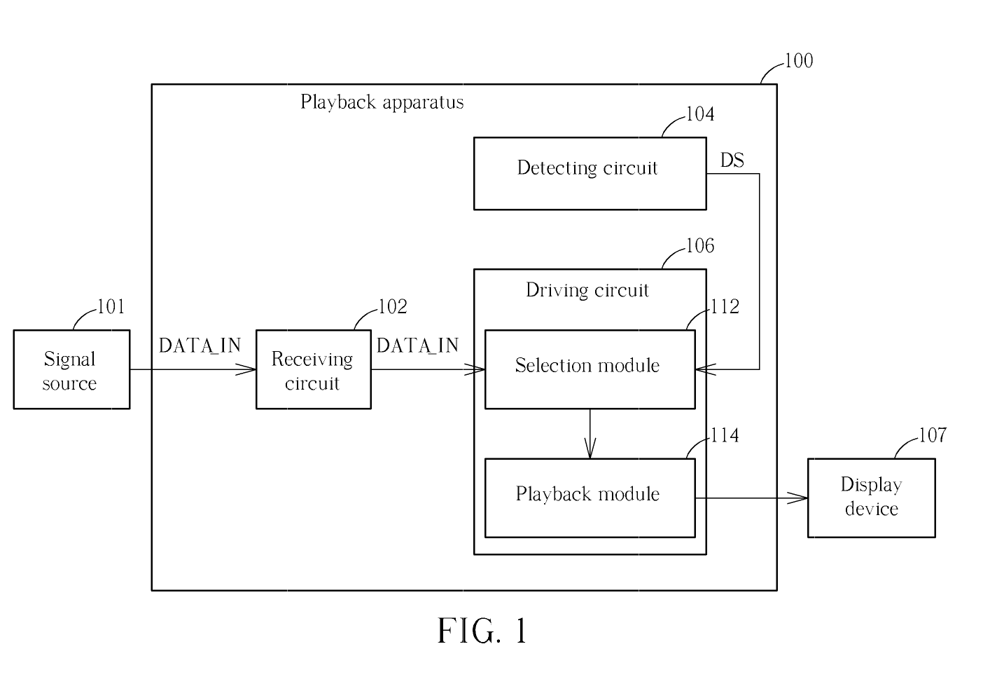

FIG. 1 is a block diagram illustrating a playback apparatus according an exemplary embodiment of the present invention. The exemplary playback apparatus 100 includes, but is not limited to, a receiving circuit 102, a detecting circuit 104, and a driving circuit 106, wherein the driving circuit 106 includes a selection module 112 and a playback module 114. The receiving circuit 102 is arranged to receive a multi-view content DATA_IN from a signal source 101. For example, the signal source 101 may be a storage medium such as a hard disk or an optical disc. The multi-view content DATA_IN includes a plurality of display data corresponding to a plurality of different predetermined viewing angles. For example, the multi-view content DATA_IN may include video bitstreams complying with a multi-view video coding (MVC) format. Therefore, video bitstreams of different viewing angles would be received by the receiving circuit 102.

The detecting circuit 104 is arranged to detect the location of each viewer and accordingly generate a detecting result DS. For example, the detecting circuit 104 generates the detecting result DS by performing a face detection. A captured image generated from an image capture device (e.g., a camera) disposed on the display device 107 may be transmitted to the detecting circuit 104. The detecting circuit 104 performs the face detection by analyzing the captured image, and then identifies faces of the viewers located in front of the display device 107. In this way, the location of each viewer can be easily detected using the face detection. In an alternative design, the detecting circuit 104 may detect the location of each viewer by detecting a location of a pair of three-dimensional (3D) glasses worn by a viewer. For example, the display device 107 has to collaborate with shutter glasses for presenting the 3D video content to the viewer. In general, the display device 107 has a signal transmitter which communicates with the shutter glasses for controlling the timing of turning on and turning off the shutter lens. The shutter glasses may be configured to generate indication signals for location identification. Thus, based on the information provided from the indication signals, the location of each pair of the 3D glasses (e.g., shutter glasses) may be easily known by the detecting circuit 104. It should be noted that the above examples are for illustrative purposes only, and is not meant to be a limitation of the present invention. That is, any technique capable of identifying the location of each viewer of the display device 107 may be employed by the detecting circuit 104.

The driving circuit 106 is coupled to the detecting circuit 104 and the receiving circuit 102, and is implemented for driving a display device 107 according to the multi-view content DATA_IN and the detecting result DS. Specifically, the driving circuit 106 refers to the detecting result DS to decide how the multi-view content DATA_IN is displayed on the display device 107. By way of example, but not limitation, the display device 107 may be a television, and the playback apparatus 100 may be a set-top box or an optical disc player such as a Blu-ray disc (BD) player.

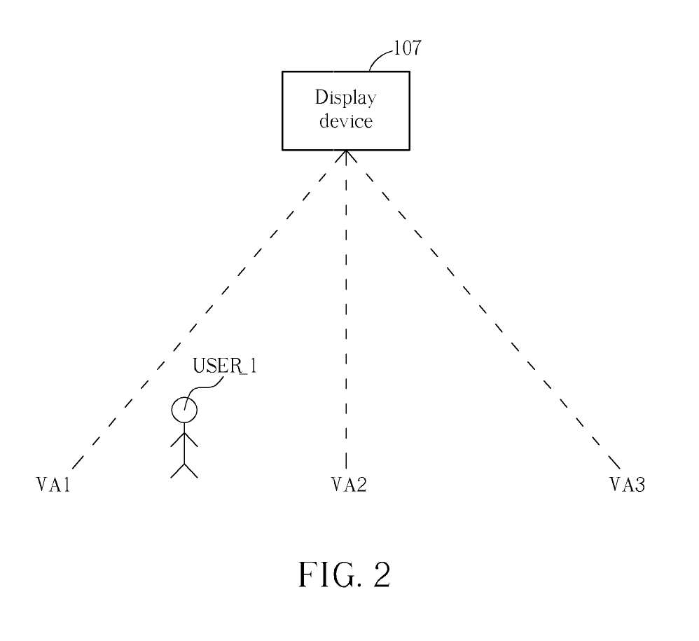

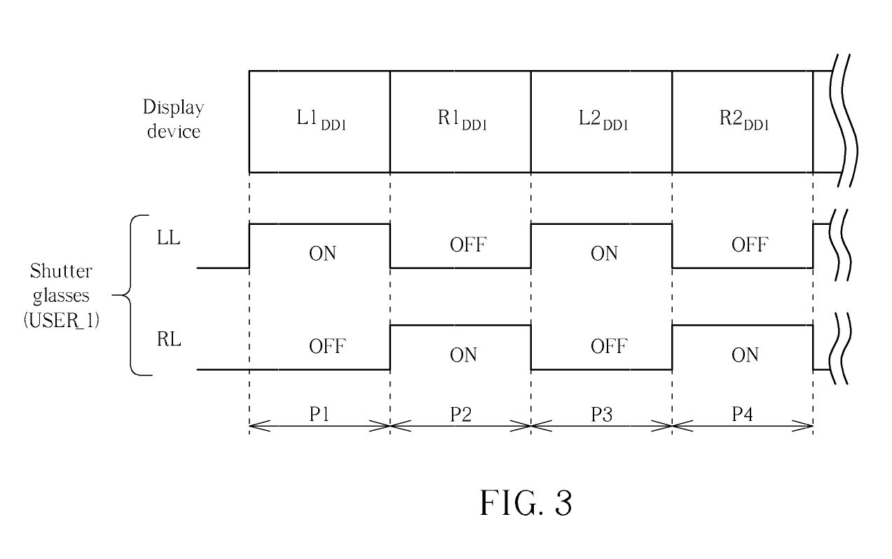

Please refer to FIG. 2, which is a diagram illustrating a first operational scenario where a single viewer is watching the display device 107. Suppose that the multi-view content DATA_IN includes a plurality of display data DD1-DD3 corresponding to a plurality of predetermined viewing angles VA1-VA3, respectively. As shown in FIG. 2, the detecting result DS generated from the detecting circuit 104 would indicate that one viewer USER_1 is located at a specific position to therefore have an actual viewing angle close to or substantially identical to the predetermined viewing angle VA1. The selection module 112 refers to the detecting result DS and then selects the display data DD1 corresponding to the predetermined viewing angle VA1 from the multi-view content DATA_IN for the viewer USER_1. Next, the playback module 114 drives the display device 107 according to the selected display data DD1. Please refer to FIG. 3, which is a diagram illustrating the operation of presenting the 3D video content to the viewer according to the first operational scenario. As shown in FIG. 3, the playback module 114 drives the display device 107 to show one left-eye image L1_{DD1}/L2_{DD1} and one right-eye image R1_{DD1}/R2_{DD1}, alternately. For example, the display device 107 has a refresh rate of 120 Hz. Therefore, left-eye images are displayed at a refresh rate of 60 Hz, and right-eye images are displayed at a refresh rate of 60 Hz. In addition, the viewer USER_1 may wear a pair of shutter glasses (not shown) having one left-eye shutter lens LL and aright-eye shutter lens RL. Each of the left-eye shutter lens LL and the right-eye shutter lens RL is controlled to switch between an open (shutter-on) state and a close (shutter-off) state. In addition, the left-eye shutter lens LL and the right-eye shutter lens RL are switched on, alternately. Therefore, the left-eye shutter lens LL is switched on to allow the left eye of the viewer USER_1 to see the left-eye images L1_{DD1} and L2_{DD1} displayed on the display device 107 during time periods P1 and P3 respectively, and the right-eye shutter lens RL is switched on to allow the right eye of the viewer USER_1 to see the right-eye images R1_{DD1} and R2_{DD1} displayed on the display device 107 during time periods P2 and P4 respectively. In this way, the viewer USER_1 can have improved 3D viewing experience since the display device 107 is properly driven by the display data DD1 corresponding to the predetermined viewing angle VA1 that is close to or substantially identical to the actual viewing angle of the viewer USER_1.

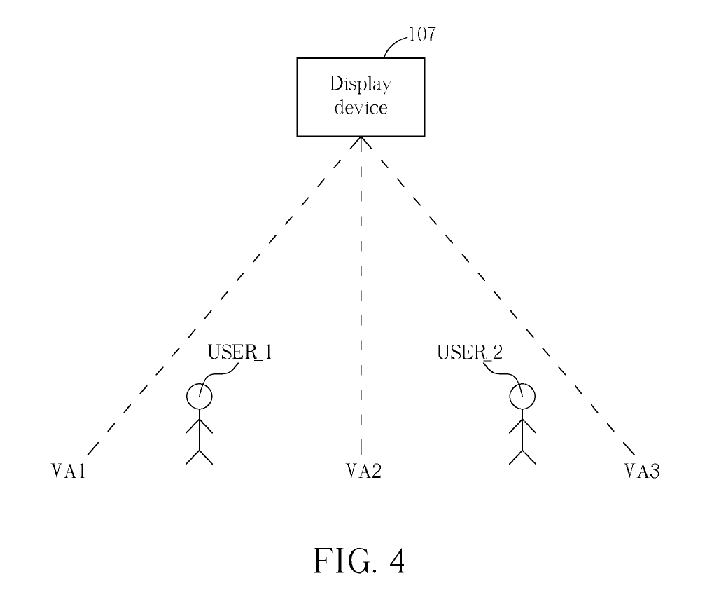

Please refer to FIG. 4, which is a diagram illustrating a second operational scenario where multiple viewers are watching the same display device 107. Suppose that the multi-view content DATA_IN includes a plurality of display data DD1-DD3 corresponding to a plurality of predetermined viewing angles VA1-VA3, respectively. As shown in FIG. 4, the detecting result DS generated from the detecting circuit 104 would indicate that one viewer USER_1 is located at a specific position to therefore have an actual viewing angle close to or substantially identical to the predetermined viewing angle VA1, and the other viewer USER_2 is located at another specific position to therefore have an actual viewing angle close to or substantially identical to the predetermined viewing angle VA3. According to the detecting result DS, the selection module 112 selects the display data DD1 corresponding to the predetermined viewing angle VA1 from the multi-view content DATA_IN for the viewer USER_1, and further selects the display data DD3 corresponding to the predetermined viewing angle VA3 from the multi-view content DATA_IN for the viewer USER_2. Next, the playback module 114 drives the display device 107 according to the selected display data DD1 and the selected display data DD3 each having a plurality of left-eye images and right-eye images to be displayed. In this exemplary embodiment, the playback module 114 drives the display device 107 to display part of the selected display data DD1 and part of the selected display data DD3, alternately. More specifically, the selected display data DD1 and the selected display data DD3 are displayed on the display device 107 in a time division manner. For example, the display device 107 may have a high refresh rate such as 240 Hz, wherein images displayed at a refresh rate of 120 Hz are for presenting the 3D video content to one viewer, and other images displayed at a refresh rate of 120 Hz are for presenting the 3D video content to another viewer.

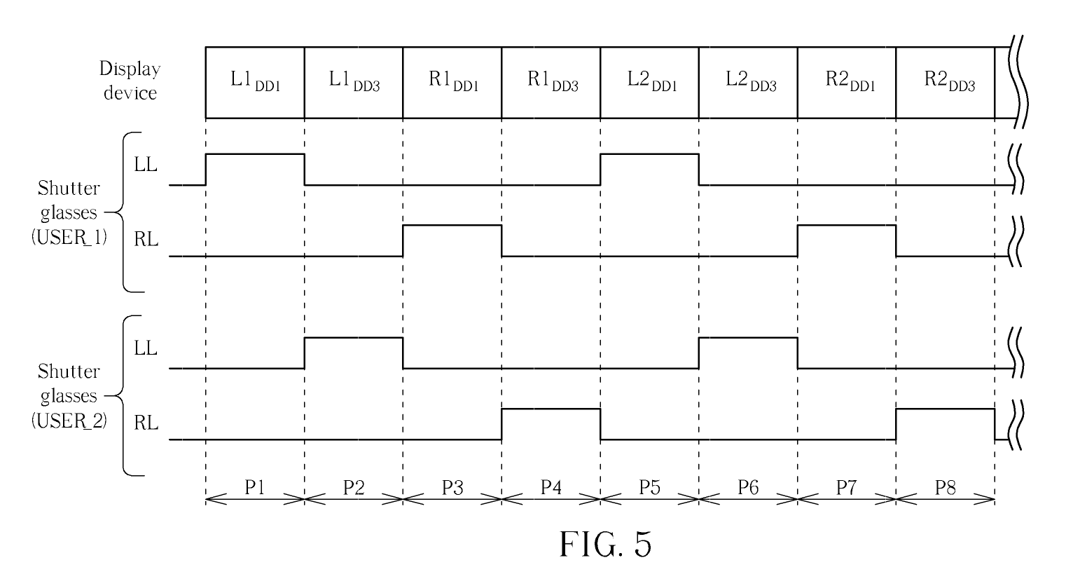

Please refer to FIG. 5, which is a diagram illustrating the operation of presenting the 3D video content to the viewers according to the second operational scenario. As shown in FIG. 5, the playback module 114 drives the display device 107 to show one left-eye image L1_{DD1}/L2_{DD1} belong to the selected display data DD1, one left-eye image L1_{DD3}/L2_{DD3} belong to the selected display data DD3, one right-eye image R1_{DD1}/R2_{DD1} belong to the selected display data DD1, and one right-eye image R1_{DD3}/R2_{DD3} belong to the selected display data DD3, alternately. Each of the viewers USER_1 and USER_2 may wear a pair of shutter glasses (not shown) having one left-eye shutter lens LL and aright-eye shutter lens RL. Each of the left-eye shutter lens LL and the right-eye shutter lens RL is controlled to switch between an open (shutter-on) state and a close (shutter-off) state. In addition, the left-eye shutter lens LL and the right-eye shutter lens RL are switched on, alternately. Therefore, the left-eye shutter lens LL of the pair of shutter glasses worn by the viewer USER_1 is switched on to allow the left eye of the viewer USER_1 to see the left-eye images L1_{DD1} and L2_{DD1} displayed on the display device 107 during time periods P1 and P5, and the right-eye shutter lens RL of the pair of shutter glasses worn by the viewer USER_1 is switched on to allow the right eye of the viewer USER_1 to see the right-eye images R1_{DD1} and R2_{DD1} displayed on the display device 107 during time periods P3 and P7; additionally, the left-eye shutter lens LL of the pair of shutter glasses worn by the viewer USER_2 is switched on to allow the left eye of the viewer USER_2 to see the left-eye images L1_{DD3} and L2_{DD3} displayed on the display device 107 during time periods P2 and P6, and the right-eye shutter lens RL of the pair of shutter glasses worn by the viewer USER_2 is switched on to allow the right eye of the viewer USER_2 to see the right-eye images R1_{DD3} and R2_{DD3} displayed on the display device 107 during time periods P4 and P8. In this way, the viewer USER_1 can have improved 3D viewing experience since the display device 107 is properly driven by the display data DD1 corresponding to the predetermined viewing angle VA1 that is close to or substantially identical to the actual viewing angle of the viewer USER_1, and the viewer USER_2 can also have improved 3D viewing experience since the display device 107 is properly driven by the display data DD3 corresponding to the predetermined viewing angle VA3 that is close to or substantially identical to the actual viewing angle of the viewer USER_2.

Briefly summarized, regarding the second operational scenario, the receiving circuit 102 is arranged to receive the multi-view content DATA_IN including at least a first display data (e.g., DD1) and a second display data (e.g., DD3) respectively corresponding to different predetermined viewing angles (e.g., VA1 and VA3), and the driving circuit 106 is implemented for driving the display device 107 to display part of the first display data and part of the second display data in a time division manner. In this way, multiple viewers would have improved 3D experience even though these viewers at different positions may have different viewing angles with respect to the same display device 107.

In above operational scenarios, the driving circuit 106 drives the display device 107 to display the display data of one predetermined viewing angle for each viewer. However, it is possible that the driving circuit 106 does not have the required computing power for processing/decoding more than one display data of a predetermined viewing angle, and/or the display device 107 fails to have a high refresh rate for supporting the playback of more than one display data of a predetermined viewing angle. The present invention therefore proposes a score mechanism employed to make the display device 107, such as a normal display device with a refresh rate of 120 Hz, present content of one selected display data of a predetermined viewing angle to more than one viewer. Further details are described as follows.

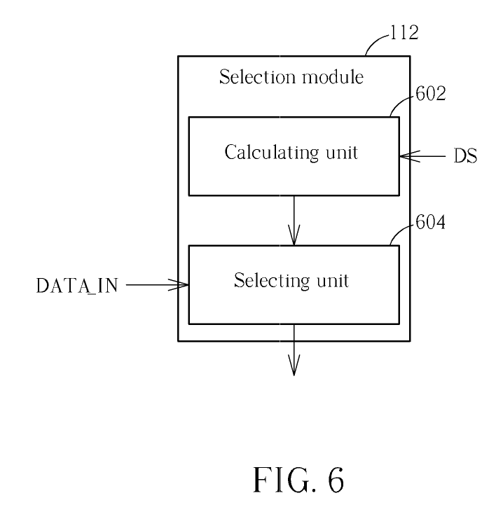

FIG. 6 is a diagram illustrating an exemplary implementation of the selection module 112 shown in FIG. 1. The selection module 112 includes a calculating unit 602 and a selecting unit 604. The calculating unit 602 is used for calculating a score value for each predetermined viewing angle by referring to a plurality of difference values between actual viewing angles of the viewers and the predetermined viewing angle, respectively. The selecting unit 604 is coupled to the calculating unit 602, and used for referring to a plurality of score values respectively corresponding to the predetermined viewing angles for selecting the display data of a specific predetermined viewing angle from the multi-view content DATA_IN.

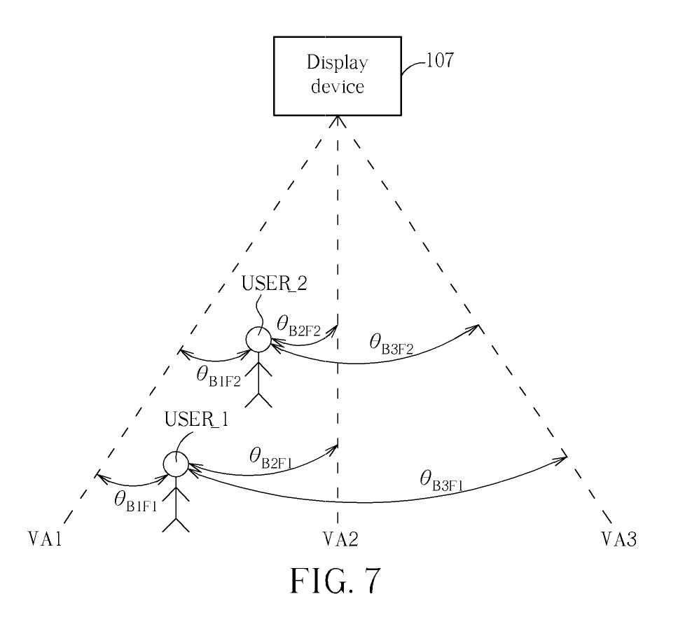

Please refer to FIG. 7, which is a diagram illustrating a third operational scenario where multiple viewers are watching the same display device 107. Suppose that the multi-view content DATA_IN includes a plurality of display data DD1-DD3 corresponding to a plurality of predetermined viewing angles VA1-VA3, respectively. As shown in FIG. 7, the detecting result DS generated from the detecting circuit 104 would indicate that one viewer USER_1 is located at a specific position to therefore have an actual viewing angle close to or substantially identical to the predetermined viewing angle VA1, and the other viewer USER_2 is located at another specific position to therefore have an actual viewing angle close to or substantially identical to the predetermined viewing angle VA2. However, due to the actual hardware design consideration/constraint, the playback apparatus 100 may be only allowed to drive the display device 107 to display one selected display data corresponding to a predetermined viewing angle. Thus, in this exemplary embodiment, the calculating unit 602 calculates a score value SCORE_{B1} for one predetermined viewing angle VA1, a score value SCORE_{B2} for another predetermined viewing angle VA2, and a score value SCORE_{B3} for yet another predetermined viewing angle VA3. In one exemplary design, the calculation of the score values SCORE_{B1}-SCORE_{B3} may be expressed as follows.

$$\begin{matrix}{SCORE}_{B 1} = ( \frac{1}{{θ}_{B 1 F 1}} + \frac{1}{{θ}_{B 1 F 2}} ) & ( 1 ) \\ {SCORE}_{B 2} = ( \frac{1}{{θ}_{B 2 F 1}} + \frac{1}{{θ}_{B 2 F 2}} ) & ( 2 ) \\ {SCORE}_{B 3} = ( \frac{1}{{θ}_{B 3 F 1}} + \frac{1}{{θ}_{B 3 F 2}} ) & ( 3 )\end{matrix}$$

In above equations (1)-(3), θ_{B1F1} represents a difference value between the actual viewing angle of the viewer USER_1 and the predetermined viewing angle VA1, θ_{B2F1} represents a difference value between the actual viewing angle of the viewer USER_1 and the predetermined viewing angle VA2, θ_{B3F1} represents a difference value between the actual viewing angle of the viewer USER_1 and the predetermined viewing angle VA3, θ_{B1F2} represents a difference value between the actual viewing angle of the viewer USER_2 and the predetermined viewing angle VA1, θ_{B2F2} represents a difference value between the actual viewing angle of the viewer USER_2 and the predetermined viewing angle VA2, and θ_{B3F2} represents a difference value between the actual viewing angle of the viewer USER_2 and the predetermined viewing angle VA3.

In an alternative design, the predetermined viewing angles may have different weighting factors assigned thereto. Therefore, the calculating unit 112 determines the score value for each predetermined viewing angle according to the aforementioned difference values (e.g., θ_{B1F1} and θ_{B1F2}/θ_{B2F1} and θ_{B2F2}/θ_{B3F1} and θ_{B3F2}) and a corresponding weighting factor (e.g., W_{B1}/W_{B2}/W_{B3}). The calculation of the score values SCORE_{B1}-SCORE_{B3} may be expressed as follows.

$$\begin{matrix}{SCORE}_{B 1} = ( \frac{1}{{θ}_{B 1 F 1}} + \frac{1}{{θ}_{B 1 F 2}} ) * {W}_{B 1} & ( 4 ) \\ {SCORE}_{B 2} = ( \frac{1}{{θ}_{B 2 F 1}} + \frac{1}{{θ}_{B 2 F 2}} ) * {W}_{B 2} & ( 5 ) \\ {SCORE}_{B 3} = ( \frac{1}{{θ}_{B 3 F 1}} + \frac{1}{{θ}_{B 3 F 2}} ) * {W}_{B 3} & ( 6 )\end{matrix}$$

After receiving the score values SCORE_{B1}-SCORE_{B3} generated from the calculating unit 602, the selecting unit 604 selects the display data corresponding to one specific predetermined viewing angle from the multi-view content DATA_IN by referring to the score values SCORE_{B1}-SCORE_{B3.} By way of example, but not limitation, the selecting unit 604 finds a maximum score value among the score values SCORE_{B1}-SCORE_{B3}, and determines the selected display data to be the display data corresponding to a predetermined viewing angle as indicated by the maximum score value.

Suppose that the multi-view content DATA_IN includes a plurality of display data DD1-DD3 corresponding to a plurality of predetermined viewing angles VA1-VA3, respectively. If SCORE_{B1}>SCORE_{B2}>SCORE_{B3}, the display data DD1 corresponding to the predetermined viewing angle VA1 will be selected by the selection module 112 and then processed by the playback module 114.

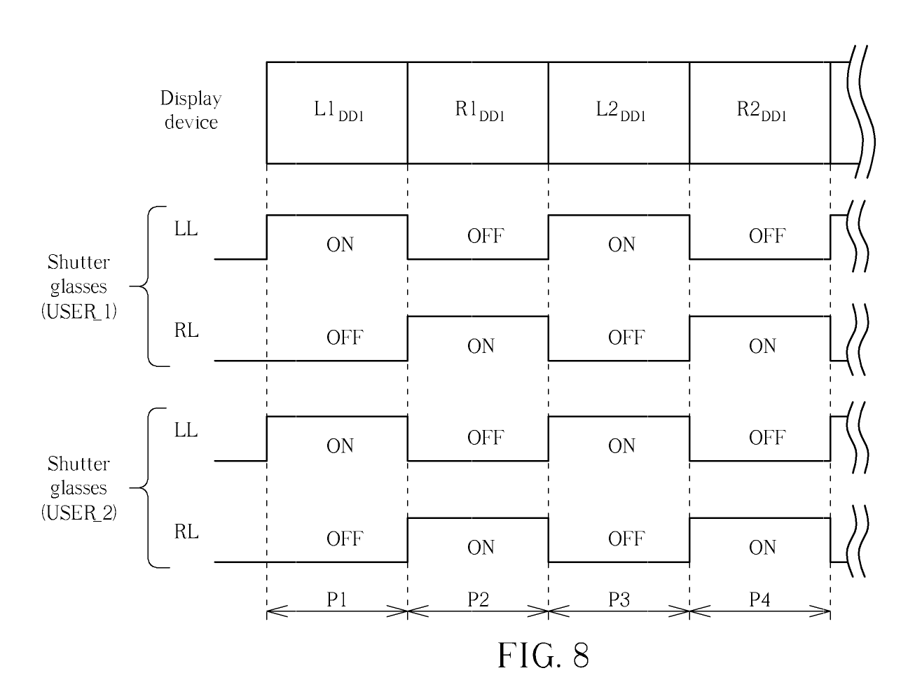

Please refer to FIG. 8, which is a diagram illustrating the operation of presenting the 3D video content to the viewers according to the third operational scenario. As shown in FIG. 8, the playback module 114 drives the display device 107 to show one left-eye image L1_{DD1}/L2_{DD1} and one right-eye image R1_{DD1}/R2_{DD1}, alternately. For example, the display device 107 has a refresh rate of 120 Hz. Therefore, left-eye images are displayed at a refresh rate of 60 Hz, and right-eye images are displayed at a refresh rate of 60 Hz. Each of the viewers USER_1 and USER_2 may wear a pair of shutter glasses (not shown) having one left-eye shutter lens LL and aright-eye shutter lens RL. Each of the left-eye shutter lens LL and the right-eye shutter lens RL is controlled to switch between an open (shutter-on) state and a close (shutter-off) state. In addition, the left-eye shutter lens LL and the right-eye shutter lens RL are switched on, alternately. Therefore, the left-eye shutter lenses LL of the pairs of shutter glasses respectively worn by viewers USER_1 and USER_2 is switched on to allow the left eyes of the viewers USER_1 and USER_2 to see the left-eye images L1_{DD1} and L2_{DD1} displayed on the display device 107 during time periods P1 and P3, and the right-eye shutter lenses RL of the pairs of shutter glasses respectively worn by viewers USER_1 and USER_2 is switched on to allow the right eyes of the viewers USER_1 and USER_2 to see the right-eye images R1_{DD1} and R2_{DD1} displayed on the display device 107 during time periods P2 and P4. Thus, though there are multiple viewers USER_1 and USER_2, the playback module 114 drives the display device 107 according to one display data that is particularly selected to make multiple viewers USER_1 and USER_2 have improved 3D viewing experience.

Those skilled in the art will readily observe that numerous modifications and alterations of the device and method may be made while retaining the teachings of the invention.

What is claimed is:

1. A playback method for processing a multi-view content, comprising:
detecting a location of each viewer and accordingly generating a detecting result; and
driving a display device according to the multi-view content and the detecting result.

2. The playback method of claim 1, wherein the step of detecting the location of each viewer comprises:
detecting the location of each viewer by performing a face detection.

3. The playback method of claim 1, wherein the step of detecting the location of at least one viewer comprises:
detecting the location of each viewer by detecting a location of at least one pair of three-dimensional (3D) glasses.

4. The playback method of claim 1, wherein the step of driving the display device according to the multi-view content and the detecting result comprises:
referring to the detecting result to select a first display data corresponding to a first predetermined viewing angle from the multi-view content for a first viewer; and
driving the display device according to at least the first display data.

5. The playback method of claim 4, wherein the step of driving the display device according to the multi-view content and the detecting result further comprises:
referring to the detecting result to select a second display data corresponding to a second predetermined viewing angle from the multi-view content for a second viewer; and
the step of driving the display device according to at least the first display data comprises:
driving the display device to display part of the first display data and part of the second display data in a time division manner.

6. The playback method of claim 1, wherein the step of driving the display device according to the multi-view content and the detecting result comprises:
referring to the detecting result to select a display data corresponding to a specific predetermined viewing angle from the multi-view content for a plurality of viewers; and
driving the display device according to the display data.

7. The playback method of claim 6, wherein the multi-view content includes a plurality of display data corresponding to a plurality of predetermined viewing angles, respectively; and the step of referring to the detecting result to select the display data corresponding to the specific predetermined viewing angle comprises:
calculating a score value for each predetermined viewing angle by referring to a plurality of difference values between actual viewing angles of the viewers and the predetermined viewing angle, respectively; and
referring to a plurality of score values respectively corresponding to the predetermined viewing angles for selecting the display data from the multi-view content.

8. The playback method of claim 7, wherein the step of calculating the score value for each predetermined viewing angle comprises:
determining the score value according to the difference values and a corresponding weighting factor.

9. A playback apparatus for processing a multi-view content, comprising:
a detecting circuit, arranged to detect a location of each viewer and accordingly generate a detecting result; and
a driving circuit, coupled to the detecting circuit, for driving a display device according to the multi-view content and the detecting result.

10. The playback apparatus of claim 9, wherein the detecting circuit detects the location of each viewer by performing a face detection.

11. The playback apparatus of claim 9, wherein the detecting circuit detects the location of each viewer by detecting a location of at least one pair of three-dimensional (3D) glasses.

12. The playback apparatus of claim 9, wherein the driving circuit comprises:
a selection module, arranged to refer to the detecting result to select a first display data corresponding to a first predetermined viewing angle from the multi-view content for a first viewer; and
a playback module, coupled to the selection module, for driving the display device according to at least the first display data.

13. The playback apparatus of claim 12, wherein the selection module is further arranged to refer to the detecting result to select a second display data corresponding to a second predetermined viewing angle from the multi-view content for a second viewer; and the playback module drives the display device to display part of the first display data and part of the second display data in a time division manner.

14. The playback apparatus of claim 9, wherein the driving circuit comprises:
a selection module, arranged to refer to the detecting result to select a display data corresponding to a specific predetermined viewing angle from the multi-view content for a plurality of viewers; and
a playback module, coupled to the selection module, for driving the display device according to the display data.

15. The playback apparatus of claim 14, wherein the multi-view content includes a plurality of display data corresponding to a plurality of predetermined viewing angles, respectively; and the selection module comprises:
a calculating unit, for calculating a score value for each predetermined viewing angle by referring to a plurality of difference values between actual viewing angles of the viewers and the predetermined viewing angle, respectively; and
a selecting unit, coupled to the calculating unit, for referring to a plurality of score values respectively corresponding to the predetermined viewing angles for selecting the display data from the multi-view content.

16. The playback apparatus of claim 15, wherein the calculating unit determines the score value for each predetermined viewing angle according to the difference values and a corresponding weighting factor.

17. A playback method for processing a multi-view content, comprising:
receiving the multi-view content including at least a first display data and a second display data respectively corresponding to different predetermined viewing angles; and
driving a display device to display part of the first display data and part of the second display data in a time division manner.

18. A playback apparatus for processing a multi-view content, comprising:
a receiving circuit, arranged to receive the multi-view content including at least a first display data and a second display data respectively corresponding to different predetermined viewing angles; and
a driving circuit, coupled to the receiving circuit, for driving a display device to display part of the first display data and part of the second display data in a time division manner.
